(19) United States
(12) Patent Application Publication
(10) Pub. No.: US 2024/0155012 A1
(43) Pub. Date: May 9, 2024

(54) WEB-BASED VIDEO CONFERENCING SYSTEM AND METHOD

(71) Applicant: ATI STUDIOS A.P.P.S. S.R.L., Brasov (RO)

(72) Inventors: Alexandru ILIESCU, Brasov (RO); Tudor ILIESCU, Brasov (RO)

(21) Appl. No.: 18/549,548

(22) PCT Filed: Mar. 11, 2022
(86) PCT No.: PCT/EP2022/056352

§ 371 Date: Sep. 7, 2023

Related U.S. Application Data
(60) Provisional application No. 63/159,679, filed on Mar. 11, 2021.

(51) Int. Cl. H04L 65/403; H04N 5/262

(52) U.S. Cl. CPC H04L 65/403; H04N 5/2628

(57) ABSTRACT

A video conferencing system (10) includes at least one audience member computing device (20) having a video display (22), a web camera (26), a speaker (30) and a microphone (24). The system (10) further includes at least one presenter computing device (20), likewise having a video display (22), a web camera (26), a speaker (30) and a microphone (24). A network (16) connects the presenter and audience member computing devices (20). A server (14) is also connected to the network (16) and includes a set of instructions (50) stored on the server (14). A bidirectional communication link extends between the server (14), the presenter computing device (20), the audience member computing device (20), and the network (16). The server (14) executes the set of instructions (50) to present a video conference between a presenter (18) and an audience member (12) in a virtual venue that is visually arranged to resemble an in-person venue.

### FIELD

The present invention relates generally to a web-based communications system, in particular to a web-based video conferencing system.

### BACKGROUND

The concept of video conferencing was first introduced in the 1870s as part of an extension of audio devices but the first actual developments of the video telephone began in the late 1920s with Bell Laboratories. Early video conferencing experiments also took place in Germany and the United States in the late 1930s. This early video technology, conducted over telephone lines, included telephones that could transmit and receive still photos. The American Telephone and Telegraph Company (AT&T) began offering video conferencing with its “Picturephone” service in the early 1970s.

Increased use of video conferencing began with the computer revolution of the 1980s. In that time period the transmission of video images became practical for personal use with the advent of video encoders-decoders (“codecs”), along with increasing availability of broadband network service.

Network-based cameras (“webcams”) began to appear on university campuses in the early 1990s. The first commercial webcam, introduced on the market in August 1994, was called QuickCam, which was compatible with Mac computers produced by Apple, Inc. A personal computer (PC) version of QuickCam was released the following year. Many businesses began to adopt video conferencing for the first time in 2004 when broadband technology became more widespread and affordable. The advent of mobile phones with video screens further increased the popularity of video conferencing. Video conferencing is now in general use by individuals, educational institutions, governments, and businesses.

Video conferencing is a cost-effective way to hold meetings, eliminating the need for travel expenses, such as hotels and airfares, to facilitate in-person meetings. An added benefit of video conferencing is that it reduces productivity losses associated with the time required for meeting participants to travel to an in-person meeting. A further advantage of video conferencing is its ability to bring together participants from around the world, dramatically increasing collaboration and productivity for many businesses.

Video conferencing became a critical tool during the COVID-19 global pandemic, allowing businesses and others to maintain productivity while reducing participants' risk of infection. Some businesses, forced to employ video conferencing during the pandemic, discovered that productivity could be maintained or even improved with remote access and video conferencing. Some companies are even considering making part-time or full-time remote access and video conferencing part of their business model, allowing them in some situations to reduce the amount of expensive brick-and-mortar office space they require.

Video conferencing provides a convenient way for participants to collaborate in real time. For example, interactive online trade shows are becoming a popular way to avoid travel expenses while still providing an effective way to market products and services worldwide. It is also an effective communications tool for such activities as writing software, designing products, educational classes, and training. In addition, video conferencing can be used for brainstorming sessions, presenting demonstration videos, and making business communication more personal than is possible with audio-only communications.

Today, video conferencing is used by many industries, including health care, law enforcement, educators, attorneys, and marketers. However, current video conferencing systems lack features to provide a virtual experience that is similar to in-person meetings. There remains a need for a video conferencing system that is similar in look-and-feel as in-person meetings. There is a further need for an efficient way to record and evaluate input from video conferencing participants.

### SUMMARY

Herein disclosed is a web-based video conferencing system and method. The method provides a multi-user platform for immersive and life-like online meeting or class experiences. The disclosed web-based conferencing system provides multi-user simultaneous assessment, automatic assessment with speech recognition, visual and audio feedback, performance reports, multi-user interaction, access to external programs and applications, and may be used on Apple computers, personal computers (PCs), mobile devices, and virtual reality (VR).

The currently disclosed web-based video conferencing system provides for a livelier and more engaging experience. The multi-user simultaneous assessment tool allows for the main user, such as a presenter or a teacher, to analyze the audience members' or students' responses while presenting or teaching. For example, in a class setting, students can learn by repeating after the teacher. The students' answers are assessed with speech recognition. The system then shows each student's answer, which the teacher can then review to identify problems. Further, the system also provides performance reports with audio recordings allowing the user, for example the teacher, to review the audience or each student's response. Moreover, the disclosed system may also provide the users with a variety of teaching or learning tools, such as the use of VR. For example, audience members or students may answer the presenter's or teacher's question using a VR chatbot.

The disclosed system also provides for multi-user interaction. Audience members, or students, may interact with each other. For example, similar to an in-person class, students may speak in pairs and the teacher can observe or interact with them. Further, unlike currently available conferencing systems, the disclosed web-based video conferencing system and method may be three-dimensional (3D). The 3D feature not only facilitates 3D movement for a more in-person interaction between participants, it also allows for the use of spatial audio, which may also increase the life-like experience. Similar to real life situations such as in a classroom, individuals who are farther from each other will hear each other less. This feature enables the users or audience members to interact with each other in a similar manner, as they would do in person.

The disclosed system and method provide the user with the ability to engage their audience using visuals and interactive features. Said features include a whiteboard with handwriting, screen sharing, document sharing and access to external programs and applications while using the system, providing for a fully and life-like collaborative experience.

### BRIEF DESCRIPTION OF THE DRAWINGS

Further features of the present invention will become apparent to those skilled in the art to which the present invention relates from reading the following specification with reference to the accompanying drawings, in which:

FIG. 1 is a diagram of a video conferencing system according to an embodiment of the present invention;

FIG. 2 shows a video rendering for the video conferencing system of FIG. 1 from the perspective of a presenter;

FIG. 3 shows a video rendering for the video conferencing system of FIG. 1 from the perspective of an audience member;

FIG. 4 is a flow diagram of the system of FIGS. 1 through 3 in operation; and

FIG. 5 is an example report generated from operation of the video conferencing system of FIG. 4.

### DETAILED DESCRIPTION

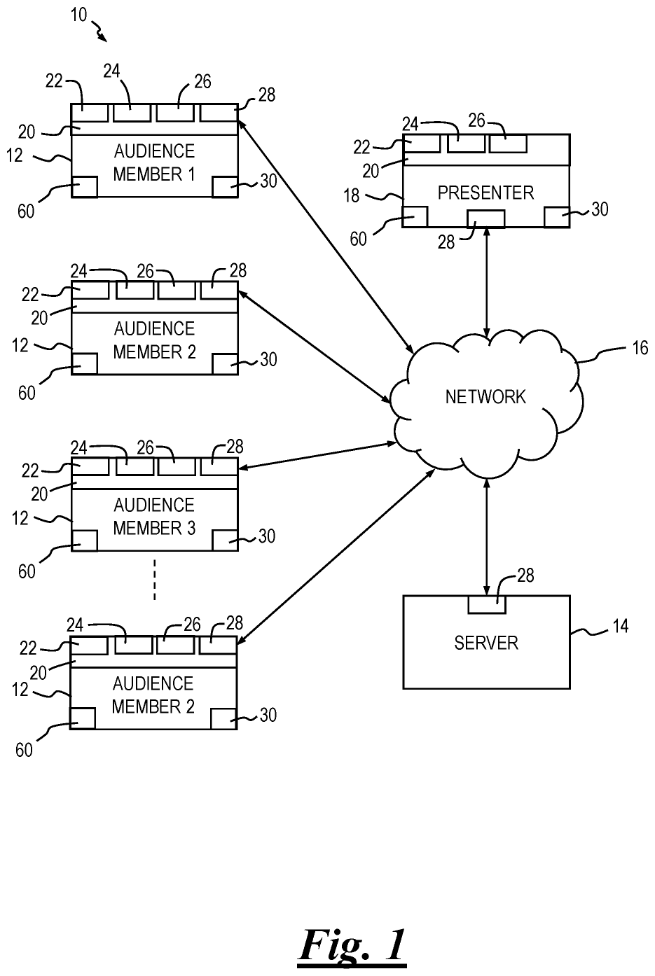

The general arrangement of a video conferencing system 10 is shown in FIG. 1 according to an embodiment of the present invention. One or more audience members 12, such as conference attendees, team members or students, communicate with a server 14 through a network 16. A presenter 18, such as a teacher, likewise communicates with server 14 through network 16.

Audience members 12 and presenter 18 may communicate with network 16 using any suitable computing device 20 such as, without limitation, desktop computers or portable computers (e.g., laptops) and mobile devices such as tablet computers and cellular telephones. Computing device 20 preferably includes a video display 22, a microphone 24, a web cam 26, a network connection 28, and a speaker 30.

Network 16 may be any suitable type of network now known or later invented. Examples include local area networks (LANS), wide area networks (WANS) and the World Wide Web (the “Web”) of the Internet.

Speaker 30 may be internal to computing device 20, or may be a separate speaker or headphones.

The aforementioned network connection 28 may be accomplished using any suitable communications devices. Example network connections 28 include, but are not limited to, wired and wireless network connections, routers, Bluetooth connections, cellular network connections, and satellite connections. Network connections 28 are preferably bidirectional to facilitate the reception to, and transmissions from, audience members 12 and presenter 18.

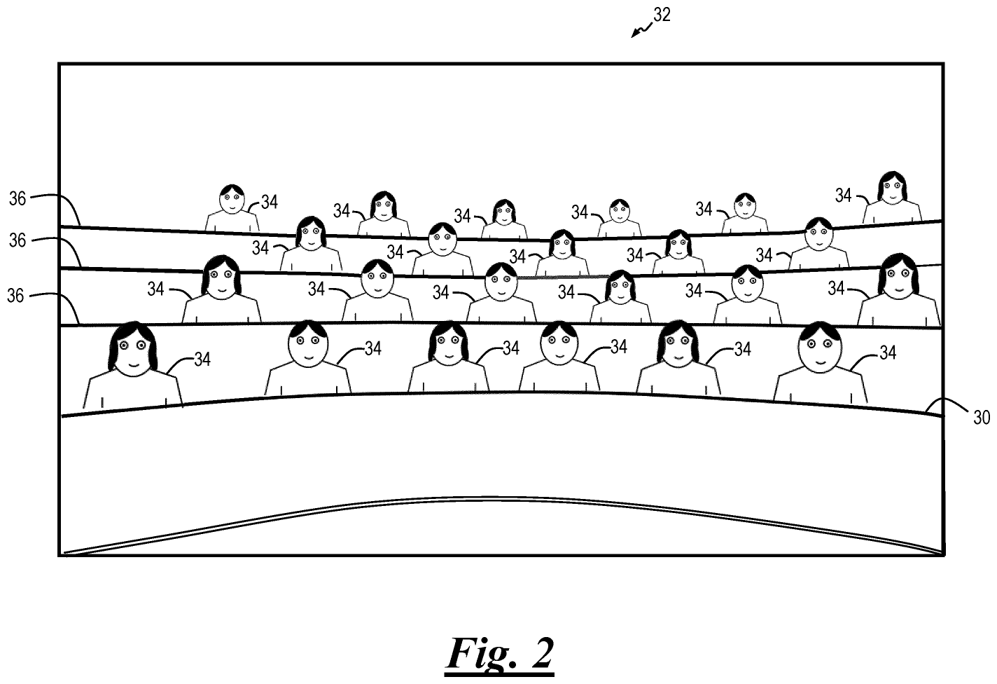

With reference now to FIGS. 1 and 2 together, a video rendering 32 of audience members 12 from the viewpoint of presenter 18 is shown in FIG. 2 according to an embodiment of the present invention. Audience member rendering 32 is an aggregation of a video image 34 of each audience member 12, captured by the audience member's corresponding web cam 28. In one embodiment, video rendering 32 includes a set of tiers 36 resembling a physical venue, such as a lecture hall, with the video images 34 of the audience members 12 being placed on the various tiers.

In some embodiments, the sizes of the video images 34 may be scaled to generally correspond with the perceived distance of the audience members 12 from a viewer of rendering 34. In this way, rendering 34 appears to the viewer to show a perspective view of audience members 12, with closer audience members being larger and more distant audience members being smaller. Audience member rendering 32 thus appears to a viewer as similar to an in-person situation, such as a classroom.

Microphones 24 (FIG. 1) allow audience members 12 and presenter 18 to each communicate aurally, the speech being heard via speakers 30. In one embodiment of the present invention, the audio generated by audience members 12 may be spatial such that the audio level generally corresponds to the audience member's “virtual distance” from the viewer as represented by rendering 34. Thus, for example, closer audience members 12 sound louder and clearer to presenter 18, while more distant audience members are not as loud. In this way, spatial audio generally replicates the aural experience of a presenter 18 at an in-person conference or meeting. The same spatial audio experience may be provided for each audience member 12, with the audio level varying for each audience member based on their distance from other audience members and presenter 18. Thus, similar to real life situations such as in a classroom, individuals who are farther from each other will hear each other less. This feature enables the presenter and audience members to interact with each other in a similar manner, as they would do in person.

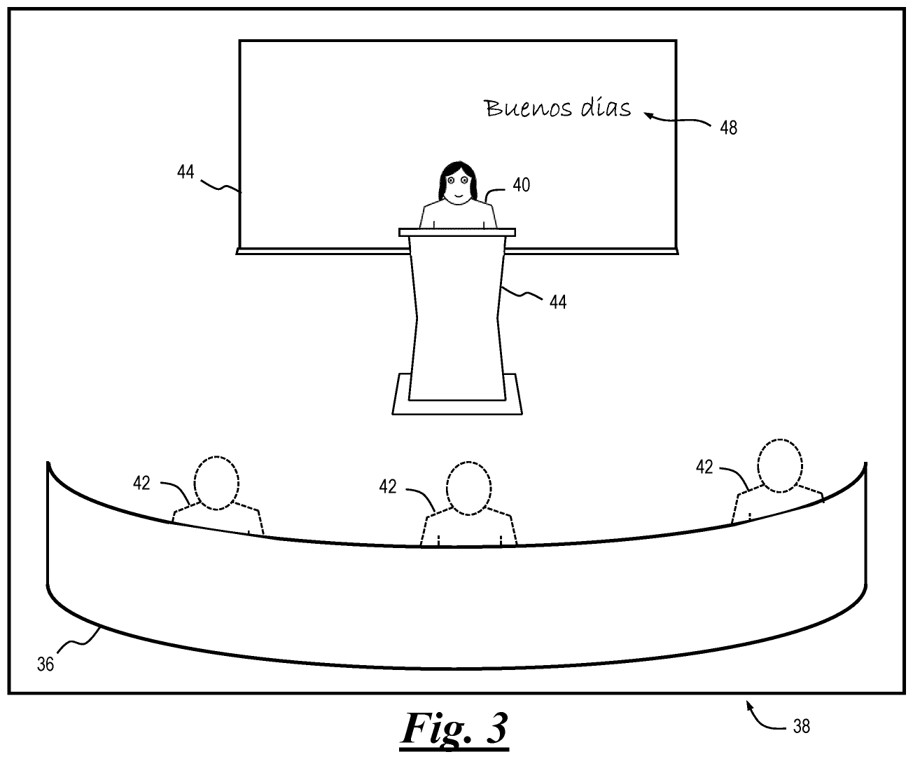

A presenter video rendering 38 from the viewpoint of audience members 12 is shown in FIG. 3 according to an embodiment of the present invention. Presenter video rendering 38 may include a video image 40 of presenter 18 and a representation of all or a portion of tiers 36 of the virtual venue. See-through representations 42 of audience members 12 may also be provided to give the audience members the look-and-feel-of sitting in an auditorium, a meeting room, a lecture hall, or the like. Video image 40 of presenter 18 may be positioned behind a podium 44. Alternatively, podium 44 may be omitted.

Presenter rendering 38 may include a whiteboard 46, and video image 40 of presenter 18 may be configured to show the presenter writing information 48 on the whiteboard, the writing being visible to audience members 12.

As can be seen from the foregoing discussion, system 10 and video renderings 32, 38 provide for a video conference between a presenter and audience members in a virtual venue that is visually arranged to resemble an in-person venue.

System 10 also provides for multi-user interaction. Audience members 12 may interact with each other and with presenter 18, and vice versa. For example, similar to an in-person class, audience members 12 may speak in pairs and presenter 18 can observe or interact with them.

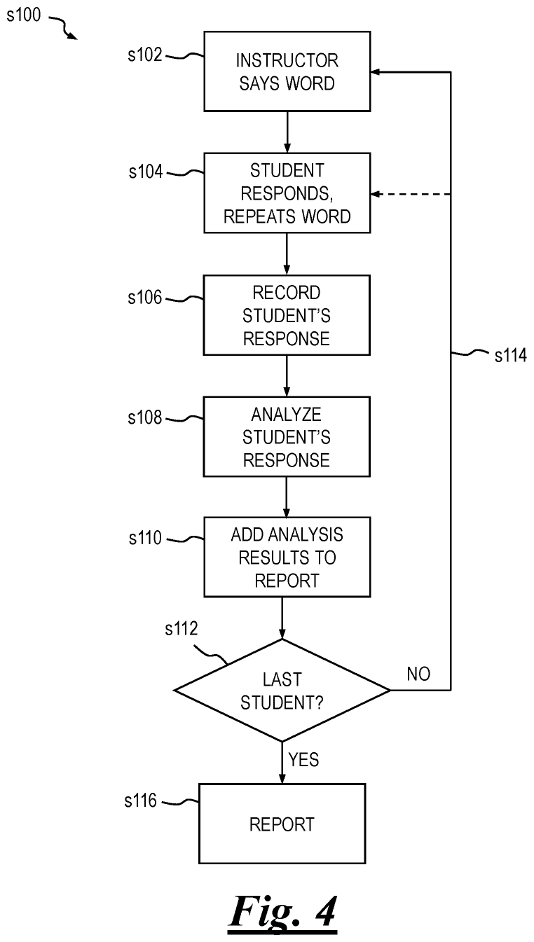

With continued reference to FIGS. 1 through 3, an example flow diagram showing operating characteristics of a process s100 of system 10 when used for the purpose of language instruction is shown in FIG. 4. System 10 is preferably an internet web-based video conferencing platform that provides multi-user simultaneous assessments. As detailed further below, system 10 includes automatic assessment with speech recognition, along with visual and audio feedback. System 10 also provides performance reports with audio recordings to allow presenters (teachers) 18 to review audience members' (students') 12 responses and pronunciations. The multi-user interaction of audience members 12 and presenter 18 provides for a virtual venue that is visually arranged to resemble an in-person venue.

At step s102, an instructor (presenter) 18 speaks into their microphone 24 and says a word, phrase or sentence in the language to be learned.

At step s104, one or more students 12 (audience members) hear in their speakers 30 the word, phrase or sentence said by instructor 18. The students 12 respond by repeating into their microphones 24 the word, phrase or sentence. Preferably, students 12 respond one at a time, in groupings of two.

At step s106, a set of instructions 50, such as a computer program, application or software (generally “software”), stored in server 14 and executed by the server to operate system 10, records the speech issued by students 12 at s104. Instructor 18 may select and listen to the responses, if desired.

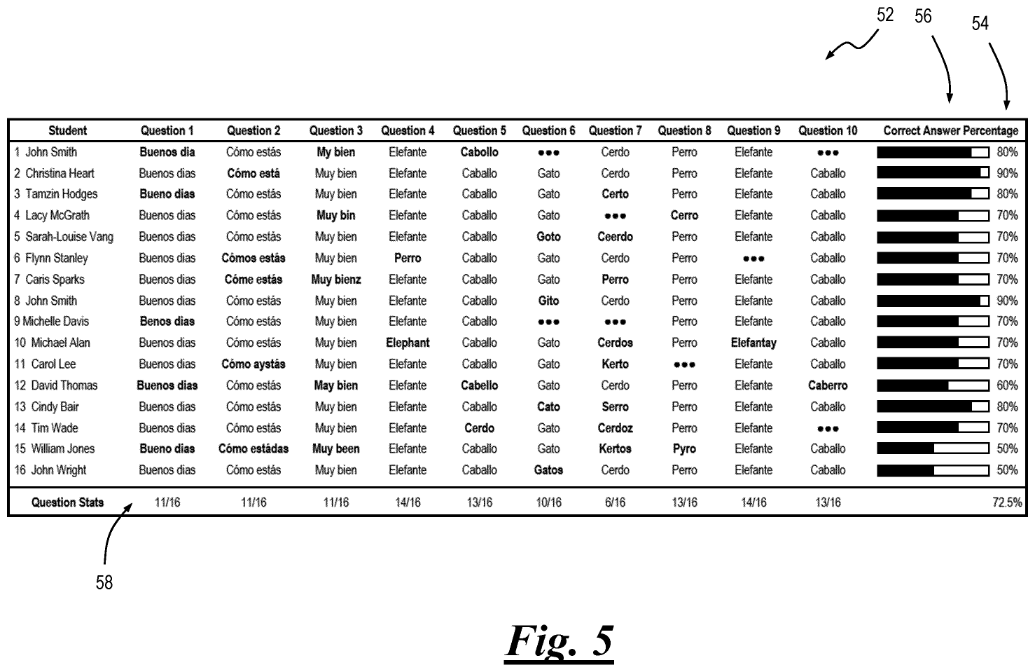

At step s108, software 50 uses speech recognition to compare the word, phrase or sentence said by the presenter at s102 to the responses of students 12 at step s104. At step s110, software 50 adds the results of the analysis to a report 52 (FIG. 5). A review is made at step s112 to see if all students 12 have responded.

If any students 12 have not responded, process s100 at step s114 returns to step s102 and presenter 18 repeats the word, phrase or sentence at step s102 with the process then continuing to the subsequent steps. Alternatively, process s100 returns to the next student at step s104 with the process then continuing to the subsequent steps.

Once all students have responded at step s112, a completed report 52 may be reviewed by instructor 18 at step s116. An example report 52 is shown in FIG. 5. Each row of report 52 is a summary of the performance of each student 12. A set of columns shows the responses of each student 12 provided at s104 to the prompts of instructor 18 at s102. If the response of each student 12 is correct, the word, phrase or sentence is listed. If the response of a student 12 is incorrect, a word, phrase or sentence showing how it was mispronounced may be displayed, if possible, and may be presented in a highlighted color, such as red. Alternatively, the positions for mispronounced words, phrases and sentences may be shown with a series of dots, an X, or the like, and may also be presented in a red color. A similar indication may be made for any students who do not respond at step s104. In another alternate embodiment, a color indication along with a symbol may be used to indicate correct and incorrect responses.

Report 52 may also include a score 54 for each student showing the percentage of correct responses. The score may also be shown in bar graph form 56. Score 54 and bar graph 56 may optionally be presented in colors indicating acceptable, marginal, and unacceptable performance with colors such as green, amber and red colors respectively. The thresholds for acceptable, marginal and unacceptable performance are flexible and may be set in software 50 by, for example, presenter 18.

Report 52 may further include a class performance calculation 58 showing a ratio of how many students 12 responded correctly to the number of number of words, phrases or sentences of step s102.

In the foregoing discussion, system 10 and process s100 are directed to language instruction. However, system 10 may be utilized in conjunction with video conferencing for any type of group setting. Non-limiting examples include instruction on subjects other than languages, presentations, team collaboration, meetings, conferences, sales presentations, and discussions.

System 10 may be provided to users with three-dimensional (3D) graphics as an element of software 50. The 3D software can also facilitate 3D movement, which can enable lifelike interaction between participants. The present invention may optionally augment the 3D graphics with the aforementioned spatial audio. With spatial audio, similar to real life, people who are farther from each other will hear each other less and vice-versa, thus providing for a group interaction closer to in-person interaction.

In some embodiments, the present invention may further include virtual reality (VR) equipment 60 (FIG. 1), permitting audience members 12 and presenter 18 to view and interact with video renderings 32, 38 virtually. Audience members or students 12 may answer a question given by the presenter or teacher 18 using a VR chatbot.

System 10 may further include screen sharing and document sharing. System 10 may further provide access to external programs and applications such as, for example, web browsers, word processors, spreadsheets, presentations, documents, and video while using the system.

From the above description of the invention, those skilled in the art will perceive improvements, changes, and modifications in the invention. Such improvements, changes, and modifications within the skill of the art are intended to be covered.

What is claimed is:

1. A video conferencing system, comprising:
at least one audience member computing device having a video display, a web camera, a speaker and a microphone;
at least one presenter computing device having a said video display, a said web camera, a said speaker and a said microphone;
a server;
a network connecting together server, the presenter computing device and the audience member computing device;
a set of instructions stored on the server; and
a bidirectional communication link between the server, the presenter computing device, the audience member computing device, and the network,
the server executing the set of instructions to present a video conference between a presenter and an audience member in a virtual venue that is visually arranged to resemble an in-person venue.

2. The video conferencing system of claim 1 wherein:
a video image of the at least one audience member is presented in a virtual venue setting from the viewpoint of the presenter,
the size of the video image being smaller for an audience member positioned at a further distance from the presenter in the virtual venue and larger for audience members positioned closer to the presenter in the virtual venue.

3. The video conferencing system of claim 1 wherein audio from the microphone of the at least one audience member is presented in the classroom setting as spatial audio wherein the audio level is lower for audience members positioned at a further distance from the presenter in the virtual venue and louder for students positioned closer to the presenter in the virtual venue.

4. The system of claim 1 wherein the set of instructions analyze at least one response of the at least one audience member to at least one corresponding question from the presenter and determines the accuracy of the student's response.

5. The system of claim 4 wherein results from the analysis are assembled into a report.

6. The system of claim 5 wherein the results include a score for the at least one audience member.

7. The system of claim 6 wherein the score is shown as a percentage.

8. The system of claim 7 where the percentage is shown in a predetermined color, the color being correlated to the percentage in a predetermined manner.

9. The system of claim 6 wherein the score is shown in a bar graph.

10. The system of claim 9 where the percentage is shown in a predetermined color, the color being correlated to the percentage in a predetermined manner.

11. The system of claim 5 wherein the report includes an audience member performance ratio indicating the number of correct responses to each question.

12. The video conferencing system of claim 1 wherein the video presented includes a video image of the presenter, shown from the viewpoint of the at least one audience member.

13. The video conferencing system of claim 12, further including a whiteboard, wherein information written on the whiteboard is viewable by the at least one audience member.

14. The video conferencing system of claim 13 wherein the video presentation shows the presenter writing on the whiteboard.

15. The video conferencing system of claim 1 wherein the network is at least one of a local area network, a wide area network, and the internet.

16. The video conferencing system of claim 1 wherein the audience member computing device and the presenter computing device further include virtual reality equipment, the virtual venue being presented in virtual reality.

17. The video conferencing system of claim 1 wherein the virtual venue presentation is three dimensional.

18. A method for video conferencing, comprising the steps of:
including at least one audience member computing device having a video display, a web camera, a speaker and a microphone;
including at least one presenter computing device having a said video display, a said web camera, a said speaker and a said microphone;
connecting a network to the presenter and audience member computing devices;
connecting a server to the network;
storing a set of instructions on the server; and
establishing a bidirectional communication link between the server, the presenter computing device, the audience member computing device, and the network,
the server executing the set of instructions to present a video conference between a presenter and an audience member in a virtual venue that is visually arranged to resemble an in-person venue.

19. The method of claim 18, further including the step of providing spatial audio for aural communications between the presenter and the audience member.

20. The method of claim 18, further including the step of providing three dimensional video communications between the presenter and the audience member.
